(19) United States
(12) Patent Application Publication
(10) Pub. No.: US 2008/0228789 A1
(43) Pub. Date: Sep. 18, 2008

(54) EDITING STRUCTURED ELECTRONIC DOCUMENT REPRESENTED BY TREE STRUCTURE IN WHICH OBJECT TO BE PROCESSED IN COMPUTER FORMS EACH NODE

(76) Inventors: Chieko Asakawa, Yokohama-shi (JP); Hisashi Miyashita, Tokyo (JP); Shin Saito, Yamato-shi (JP); Hironobu Takagi, Yokohama-shi (JP)

Correspondence Address: LAW OFFICE OF IDO TUCHMAN (YOR), ECM #72212, PO Box 4668, New York, NY, 10163-4668, US

(21) Appl. No.: 12/049,346

(22) Filed: Mar. 16, 2008

(30) Foreign Application Priority Data
Mar. 16, 2007 (JP) 2007-68269

(51) Int. Cl. G06F 17/30

(52) U.S. Cl. 707/100; 707/E17.012

(57) ABSTRACT

A computer program for editing a structured electronic document that is represented by a tree structure, in which an object to be processed by a computer forms each node, is provided. The program causes the computer to operate as (1) means for selecting a predetermined node from the nodes, (2) means for selecting at least another node that is placed after the predetermined node in the tree structure, (3) means for determining whether semantics of the selected other node are associated with semantics of the predetermined node or not, and (4) means for changing the tree structure so that the other node becomes a child node of the predetermined node if it is determined that the association is available.

### CROSS-REFERENCE TO RELATED APPLICATIONS

This application claims priority under 35 U.S.C. §119 to Japanese Patent Application No. 2007-68269 filed Mar. 16, 2007, the entire text of which is specifically incorporated by reference herein.

### BACKGROUND OF THE INVENTION

(1) Field of the Invention

The present invention relates to a computer program for editing a structured electronic document that is represented by a tree structure, in which an object to be processed in the computer forms each node, a method and a device using the same. Specifically, the present invention relates to a computer program that can change the tree structure in response to operation of a user on the structured electronic document shown on a display and change its operation specification of the electronic document in order, a method and a device using the same.

(2) Description of the Related Art

Many multi-media content are used on the WWW (World Wide Web). As for the multi-media content, such a technique for dynamically changing a graphically displayed content as the SVG (Scalable Vector Graphics), DHTML (Dynamic HTML) or the Adobe Flash is used to provide affluent types of the content representation.

A multi-media content generally includes texts, graphic data and programs that are associated with each other in a hierarchical structure. The hierarchical structure is typically represented by a tree structure. The tree structure may make a base for a guide for a user who is viewing and operating the multi-media content.

For example, if the content introducing activity of a company is represented in a tree structure with each node of the tree corresponding to each branch office or each division of the company, a user can easily recognize the organization structure of the company as the user browses the content. As the user recognizes the organization of the entire company, the user can also recognize the content corresponding to child nodes belonging to each organization. That also helps the user in searching the desired content.

As described above, if the multi-media content is represented by a tree structure which is arranged from a viewpoint of semantics of each node, the content is convenient for those visually impaired. It is difficult for those visually impaired to immediately recognize the content shown on a computer display. Thus, that kind of user typically has the content shown on the computer display read aloud sequentially by using a text-to-speech technique, and accesses the content present at deepest layer according to the audio guide. The user accumulates knowledge on the content by repeating the operation.

However, sub-content included in the existing multi-media content on the WWW are not necessarily arranged in a tree structure from the semantics viewpoint. It may be troublesome for a person who designs, maintains or updates such multi-media content to closely examine what the sub-content mean and arrange them in an appropriate tree structure. Accordingly, it is quite difficult for those visually impaired to recognize the content that is shown on a computer display and read aloud along with the tree structure to access the desired sub-content. For example, the user may encounter the content which does not match the context shown by the tree structure that the user has traced.

Even if a plurality of content associated with each other in the semantics viewpoint is displayed close on a computer display, the content may be at a distance from each other on a tree structure (for example, with no such relationship as siblings or parent-child). In such a case, it may be difficult for the user to recognize all of the plurality of content associated with each other. This is because such a plurality of sub-content is read aloud at distant timing by an audio guide.

Published Unexamined Japanese Patent Application No. 2004-178015 describes a hierarchical structure displaying device and method that enables inclusion of classes in a hierarchical database to be appropriately and effectively displayed. The patent document, however, does not disclose a technique for correcting inconsistency between the semantics of the sub-content suggested by the place in the tree structure and the semantics of the sub-content that can be suggested or recognized from a presentation aspect of the sub-content shown on the computer display.

Published Unexamined Japanese Patent Application No. 2006-103280 discloses a printer for printing structured document of a content described in a structured language after replacing them with a parsed tree consists of a plurality of elements, but it does not disclose a technique for reviewing and rearranging the parsed tree from the semantics viewpoint of the content. With the abovementioned Adobe Flash, the content is displayed based on a structured Ordered Tree, but the once formed tree structure cannot be rearranged.

Assets2006 Saito, Takagi, and Asakawa, Transforming Flash to XML for Accessibility Evaluations, In proceedings of The 8^{th} international ACM SIGACESS conference on Computers and Accessibility, pp. 157-164, 2006, discloses a method for obtaining a tree structure of an existing flash content with ActionScript by dynamically inserting a bridge in the existing flash content via a proxy. The non-patent document, however, neither discloses nor suggests a method for changing the obtained tree structure.

### BRIEF SUMMARY OF THE INVENTION

In view of the above limitations of the conventional art, it would be beneficial to change a data structure of content in a system, in which an audio guide performs content navigation, so that relationship between sub-contents that can be visually understood is reflected to the data structure. It is further desirable to enable a user who cannot view the content to perform appropriate content navigation by implementing the audio guide based on the changed data structure.

According to one aspect of the present invention, a computer program for editing a structured electronic document that is represented in a tree structure, in which an object to be processed in the computer forms each node, is provided. The program causes the computer to operate as each of means below: (1) means for selecting a predetermined node from respective nodes; (2) means for selecting at least one another node which is placed after the predetermined node in the tree structure; (3) means for determining whether the semantics of the selected another node are associated with the semantics of the predetermined node or not; and (4) means for changing the tree structure to make the other node a child node of the predetermined node if it is determined that the association is available.

While a user of the computer is operating the predetermined node on the tree structure, determination on whether the predetermined node has semantic relation with another node that is placed after the predetermined node or not is performed. The tree structure is changed based on the determination. Therefore, the semantics of the object suggested by the place of the object in the tree structure and the semantics of the object represented on the computer display match. Accordingly, an aspect of the present invention enables those visually impaired to correctly recognize the semantics of each object actually shown on the computer display by letting those visually impaired browse each object along with the tree structure.

The abovementioned determining means enables determination based on a presentation aspect of each object corresponding to a predetermined node and another node on the computer display. When at least a part of the object corresponding to the predetermined node is overlapping the object corresponding to another node on the computer display, the determining means may determine that the semantics of another node are associated with the semantics of the predetermined node. If it is not determined that they cannot be associated with each other and if the other node is a descendant of the predetermined node, the tree structure may be changed so as to make the other node a preceding sibling of the predetermined node.

The means for selecting another node may select at least one another node from the preceding sibling node of the predetermined node or descendant nodes of the preceding sibling node. Limiting the object of rearranging the tree structure to nodes after the predetermined node in the tree structure has the following advantages: If the predetermined node is the node that is currently browsed by the user, the tree structure that has been traced by the user will not be changed. That enables the user to keep browsing based on the recognized tree structure. Limiting the object of rearranging the tree structure improves performance so that the tree rearrangement can follow the browsing operation by the user more quickly.

The object of the tree rearrangement can be also broaden as required so that means for selecting another node may select at least one another node also from nodes that is the parent node of the predetermined node or descendants of the parent node and placed after the predetermined node. The means for selecting a predetermined node may be adapted to select a node as a predetermined node that corresponds to an object, whose content are being read aloud by a text-to-speech device of the computer.

The other features of the present invention will be apparent from the description on a preferred embodiment to implement the present invention shown below.

### BRIEF DESCRIPTION OF THE SEVERAL VIEWS OF THE DRAWINGS

FIG. 1 is an outlined diagram of hardware configuration for implementing a computer device 100 of the present invention;

FIG. 2 is a functional block diagram of the computer device 100 of the present invention;

FIG. 3 is a processing flow diagram of a structured document;

FIG. 4 is a plane view of a Web page to be operated by the computer device 100 of the present invention;

FIG. 5 is a diagram showing a tree structure of the Web page;

FIG. 6 is a diagram showing the tree structure changed by the computer device 100 of the present invention;

FIG. 7 is a flow diagram showing a processing procedure taken by the computer device 100 of the present invention;

FIG. 8 is a plane view of another Web page processed by the computer device 100 of the present invention;

FIG. 9 is a diagram showing the tree structure of another Web page;

FIG. 10 is a plane view of the latter Web page on which a user clicked on Item1; and

FIG. 11 is a diagram showing the tree structure of the Web page generated by the computer device 100 of the present invention after it is clicked.

### DESCRIPTION OF SYMBOLS

100 . . . Computer device

102 . . . Memory

104 . . . CPU

110 . . . Keyboard

116 . . . Display

120 . . . HDD

126 . . . Audio processing unit

204 . . . Content analyzing unit

206 . . . Content structure storing unit

208 . . . Node selecting unit

210 . . . Determining unit

212 . . . Content structure changing unit

400 . . . Example of Web content

500 . . . Initial tree structure of Web content 400

600 . . . Changed tree structure of Web content 400

800 . . . Another example of Web content

### DETAILED DESCRIPTION OF THE INVENTION

### A. Terminology

First, terms used through the specification will be described:

Object—In the specification, the term means (1) data or a content displayed as graphic or character on a computer display, (2) data to be processed by a computer program, or (3) a program code or the like in a computer executable form, according to the context.

Content—In the specification, the term ‘content’ may be used as a synonym of an object according to the context. Such an object that can be recognized as collective information on a computer display such as an icon, a text or the like is sometimes called ‘content’. In another case, a group of displayed objects that form a Web page is collectively called as ‘content’.

Tree structure—One of the representation forms of the structure of multi-media content. Typically, a multi-media content is stored in a computer such as a server in the form of XML information. If relationship between sub-content which form the multi-media contents is extracted from the XML information, the relationship is represented in such a tree structure as that exemplified in FIG. 5. Each node corresponds to each sub-content. The sub-content is associated with each other by parent-child relationships, sibling relationships or the like. These relationships are represented by lines. Here, the meaning of parent-child, siblings and the like, and ordering of parent-child nodes and sibling nodes in a tree structure follow the definition used in a field of data structures. In the specification, such a term as a tree structure or a node is sometimes used as an object to be processed by a computer. For those skilled in the art, it is easily understood that the abovementioned abstract relationship between the sub-contents is not used as an object to be processed but that data to be represented in a tree structure and stored in a computer is used as the object to be processed.

Semantics—In the specification, the term ‘semantics’ means what kind of reality, notion or presentation aspect is associated with a certain content. The content associated with reality, notion or representing aspect that is in such relationship as the same kind of concept, the broader term or the narrower term are sometimes grouped and shown on a computer display. Typically, the content with the similar semantics is displayed near to each other, the content whose semantics are in such relationship as the broader term or the narrower term is often displayed in hierarchy. Specifically, any display medium using a computer is adapted to enable a user to recognize association of the semantics of respective content from the representing aspect on the computer display of the content. Based on the empirically obtained knowledge, it can be determined that the semantics of the contents displayed near on the computer display are near to each other. For example, it may be determined that two kinds of content whose displayed regions are in inclusion relationship on the computer display are also in the inclusion relationship from the semantics viewpoint. Specifically, when display regions on the computer display for the two kinds of content are in inclusion relationship, it may be determined that the semantics of the two kinds of content are associated with each other. The criterion for determining the association of the semantics of two kinds of content are not limited to the inclusion relationship of the display regions and a degree of overlapping, contrast of colors and the like may be used as the criterion.

### B. Hardware Configuration

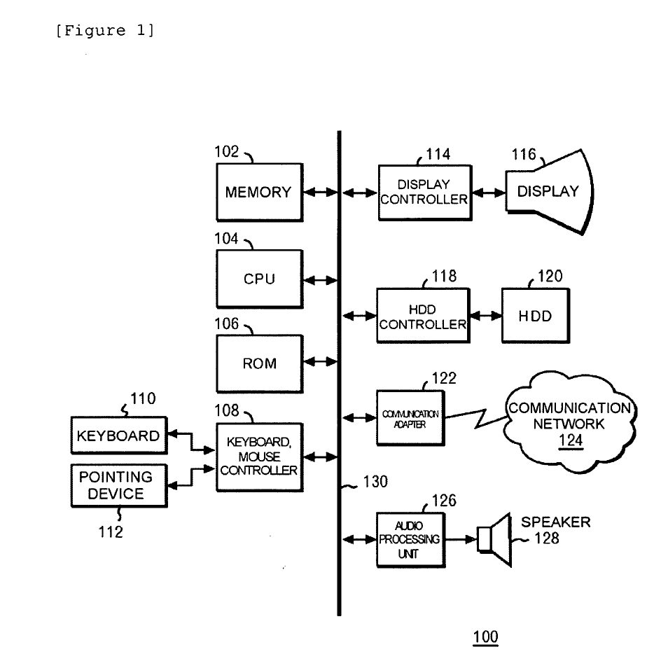

FIG. 1 is a schematic diagram of a hardware configuration for implementing a computer device 100 of the present invention. The computer device 100 includes a central processing unit (CPU) 104 and a memory 102. The CPU 104 and the memory 102 are connected with a hard disk device 120, which is used as auxiliary storage, via a bus 130 and a hard disk controller 118. A storage medium such as the hard disk device 120 or a ROM 106 can record a computer program code or various kinds of data for implementing the present invention by giving a command to the CPU 104 in conjunction with an operating system.

The computer program code is executed as it is loaded on the memory 102. The computer program code may be divided into a plurality of parts and recorded across a plurality of storage media. Alternatively, a part of the code divided into a plurality of parts may be recorded in the storage medium in another information processing unit, which is connected with the computer device 100 via a communication adapter 122 and a communication network 124, so that the divided codes cooperate with each other. Distributing the divided codes in a plurality of devices so that the codes are cooperating with each other is embodied as a client server system, for example. Which code respective devices execute to realize respective functions can be selected as required when the system is designed. The present invention includes any aspects of them.

The computer device 100 further includes user interface hardware. As the user interface hardware, a pointing device (a mouse, a joystick, a touch pad and the like) 112 for inputting screen position information, a keyboard 110 for supporting key input, and a display 116 for presenting a document image to be edited to a user are used. The computer device 100 may also include an audio processing unit 126. For example, the computer program executed by the CPU 104 may be stored in the memory 102 to send the content of the data shown on the display 116 to the audio processing unit 126. The audio processing unit 126 converts the data into audio signals and the audio is output from a speaker 128. According to the series of processes, the content shown on the display is read aloud by audio.

The abovementioned hardware configuration can be embodied as any type of information processing unit such as a personal computer, a workstation, a unit of business equipment, an electronic home appliance, a cellular phone, an in-car system and the like. The abovementioned components are merely an example. Not all of the components are required to form the present invention. As an operating system, what supports the graphic user interface multi window environment as a standard such as Windows® (Registered trademark), XP®, AIX®, Linux® is desirable, but the other operating system may be used. The present invention is not limited to a particular operating system environment.

### C. System Configuration

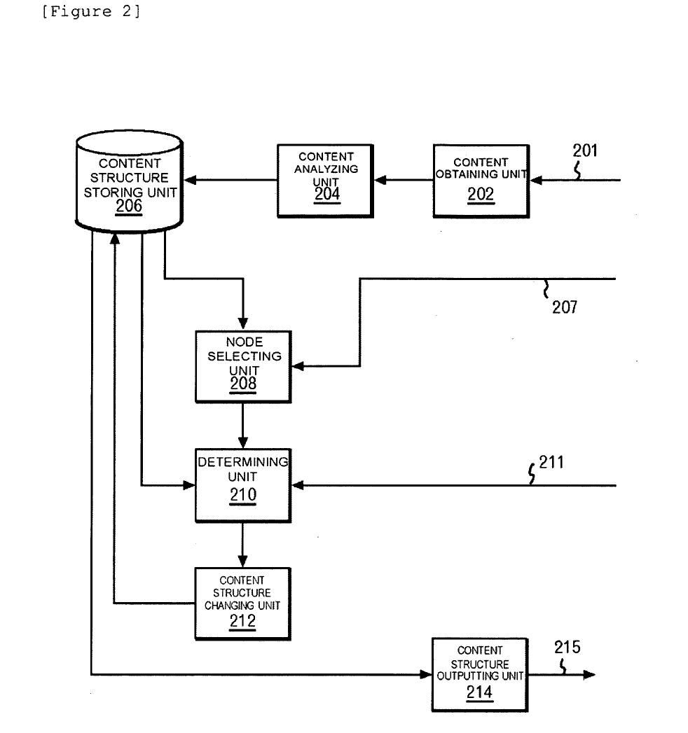

Now, a system configuration of the present invention will be described with reference to FIG. 2. The functional blocks shown in FIG. 2 are logical functional blocks and do not necessarily mean that they are realized by integrated hardware or integrated software. Each of the functional blocks can be embodied by independent hardware units or cooperation of the hardware units or by common hardware or common software.

In an embodiment of the present invention, the computer device 100 includes a content obtaining unit 202, a content analyzing unit 204, a content structure storing unit 206, a node selecting unit 208, a determining unit 210, a content structure changing unit 212, and a content structure outputting unit 214. The content is preferably a structured document, such as a Web page or a document described in the XML.

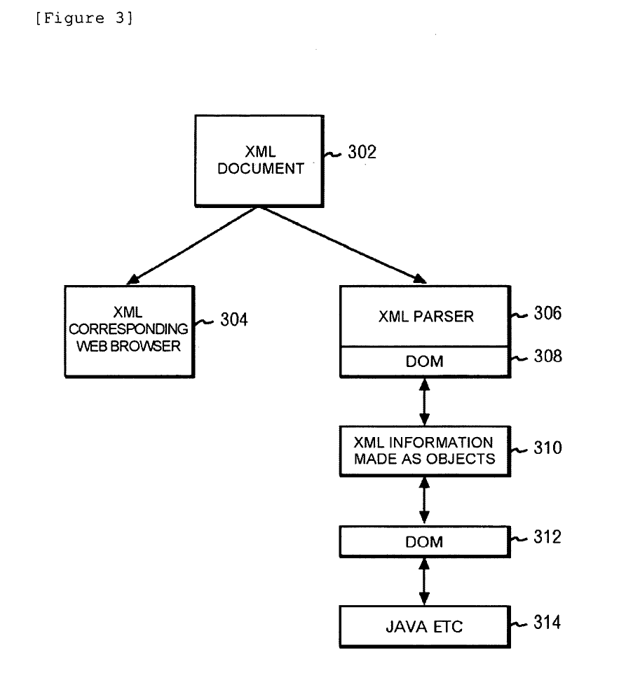

Here, prior to describing the computer device 100 in detail, the object and the operation taken by the computer device 100 in a computer network system represented by WWW will be described. FIG. 3 is a flowchart for illustrating how the content such as a Web page are processed by a computer or a software program running on the computer in a computer network system. The content is described in e.g., XML, and stored in the computer such as a web server in the form of XML document 302. There are roughly two ways to display the XML document 302 on a display of a client computer that is operating under a user of each computer. One of them is a method for displaying content on a display of a client computer by using a Web browser 304 that accepts XML documents on the client computer and operating the browser to analyze the XML document 302.

The other is a method of causing an XML parser 306 to analyze an XML document 302, and using DOM (Document Object Model) 308 to convert the XML document into objects based on the analysis. The XML information 310 made as objects is further processed by another software program 314 described in such a programming language as Java® (Registered Trademark) via another software program 312 with DOM and shown on the display of the computer.

Any of the abovementioned method has processing of both analysis of a structured document and inputting from a user. A method, a device, and a software program for editing the structured document according to the present invention may be interleaved or added to the analysis of the structured document or the inputting from a user. For example, a program according to the present invention may be embodied as a part of the XML corresponding Web browser 304 or a part of the XML parser 306.

How the function realized by embodiments of the present invention can be distributed in the processing flow shown in FIG. 3 can be selected as required according to a configuration of a computer network. The aspect of how the function is distributed is not limited to a particular one. In short, even if the computer device, the program, and the like according to the present invention are implemented in any aspect of the processing on a structured document as shown in FIG. 3, the essence of the present invention is not changed.

Returning to FIG. 2, the operations of respective units of the computer device 100 will be described. The content obtaining unit 202 accesses a structured document such as XML document stored in a server or the like, causes the memory 102 or the hard disk device 120 of the computer device 100 to store the document, and informs the content analyzing unit 204 of the place. The abovementioned operation may be triggered by any of operations by a user on the XML corresponding Web browser 304 and activation of the XML parser 306.

The content analyzing unit 204 analyses the structure of the structured document obtained by the content obtaining unit 202 and causes the content structure storing unit 206 to store the analysis. Here, the content analyzing unit 204 may analyze all or a part of the obtained content.

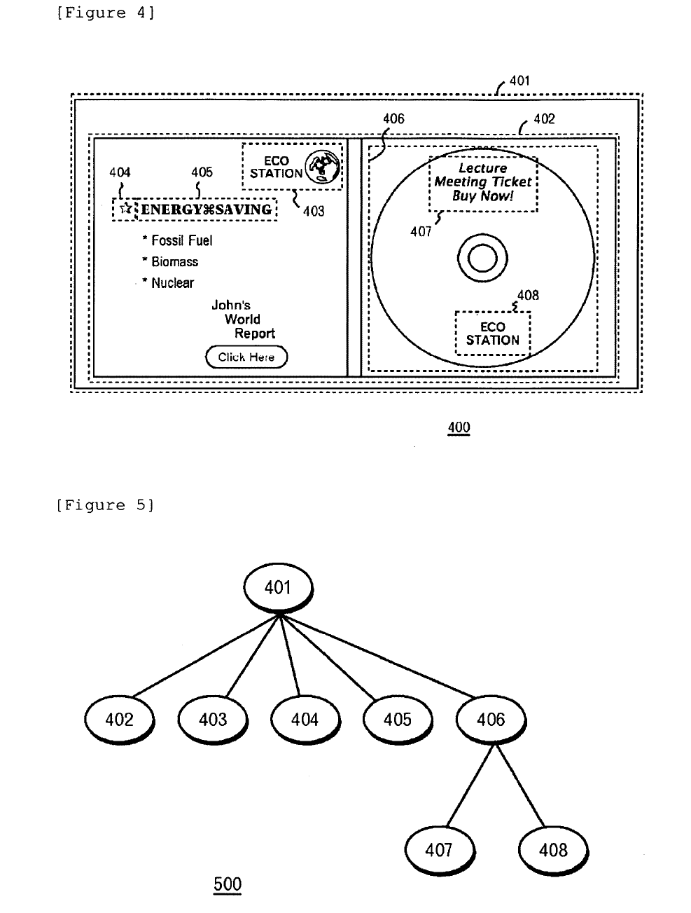

In an aspect of the present invention, the content analyzing unit 204 desirably analyses a part of content in response to the user's input, for example, objects operated by the user as well as the surroundings in the tree structure, as mentioned later. A case where the entire of the Web page (content) shown in FIG. 4 is analyzed by the content analyzing unit 204 will be described for the convenience of the description.

The Web page shown in FIG. 4 is for introducing a DVD and its content that are distributed to the consumers by an environmental protection organization for free for the purpose of enlightenment. An image 402 that looks like a DVD jacket is displayed on a background image 401. On the left half of the screen, the items of the content of the DVD are shown in a menu style. A displayed object 403 is a logo mark representing the organization. Both of the displayed objects 404 and 405 represent the title of the DVD. Under the title, the items are listed. Under the items, the title of a report by a special event is displayed. A viewer of the Web page can have the content of the DVD displayed on a computer display by clicking on the item.

As mentioned above, on the left half of the screen, matters relating to the content of the DVD are listed. On the right half of the screen, an advertisement of a lecture 407 and the logo mark of the organization 408 are superimposed on an image 406 that looks like a DVD disk. That is, objects representing information for different purposes are displayed in the right half and the left half of the screen.

The Web page 400 is typically described in XML as mentioned above. By analyzing description in XML, a tree structure of the Web page can be obtained. FIG. 5 shows a tree structure that is obtained as the content analyzing unit 204 analyses the description in XML of the Web page 400. Each of the displayed objects from 402 to 406 is a child of the object 401, which represents the background. Each of the displayed objects 407 and 408 is a child of the displayed object 406, which represents the DVD.

The tree structure is stored in the content structure storing unit 206. Those skilled in the art may select a form to represent the tree structure stored in the content structure storing unit 206 by using a well-known technique as required. For example, the tree structure may be represented with each node of the tree as a set of a name of a displayed object, a pointer to data of the object, and pointers to child nodes and parent nodes.

The right half and the left half of the screen 400 have different meanings to be presented to the user as mentioned above. The right half is meant for giving information on the lecture and the left half is meant for introducing the content of the DVD. A user who can see the entire image of the Web content 400 can understand the difference between the purposes of them from presentation aspects of the displayed objects, for example, an arrangement of the objects and a distance between them. A vision-impaired user cannot understand them so easily. A vision-impaired user needs a guide from the computer system based on the tree structure shown in FIG. 5.

For example, the computer system shows the Web content 400 on the display, and then serially reads aloud the content of the displayed objects 401, 402, 403, 404, 405 and 406 based on the tree structure 500. The user who is listening to the guide can understand that the objects from 402 to 406 belong to the object 401.

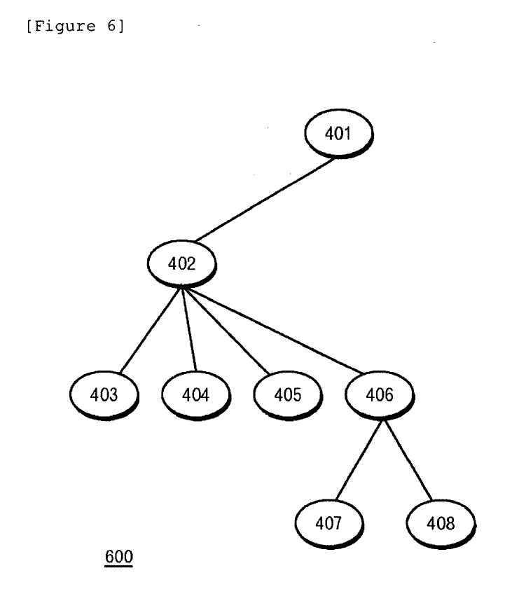

As mentioned above, however, the objects should be actually grouped and guided according to the similarities of their meanings such that the object 401 represents a casing of the CD, the objects 402 to 406 represent guide of the content of the DVD, the objects 407 and 408 represent guide of the lecture. A method for reducing the difference between the abovementioned structure of the Web content understood by a user viewing the Web content and the structure of the Web content represented in the tree structure obtained by analyzing the content obtained by the content analyzing unit 204 will be described in detail with reference to FIG. 6.

Let us take up the discussion on FIG. 2. The content structure storing unit 206 stores the abovementioned tree structure of the Web content. As described above, the entire of the tree structure of the Web content does not need to be stored at a time. A part of the tree structure, which is lazily generated as the user operates the Web content, may be stored. When the content of the Web content operated by the user is sent from the computer system (207), the node selecting unit 208 selects a node included in the tree structure stored in the content structure storing unit 206.

The selected node is also referred to as an object node. Specifically, when the user selects the displayed object 402, for example, the unit selects the corresponding node in the tree structure. The audio processing unit 126 may be caused to read aloud text included in the displayed object, when the selection is done. In such a case, the read aloud node is the start node. Hereinafter, the node selected in such a manner will be called ‘start node’ to mean a node that is first subjected to reconfiguration when the tree structure is about to be reconfigured.

The determining unit 210 serially determines whether the tree structure needs to be changed or not from the start node informed from the node selecting unit 208 to the nodes surrounding the start node. Preferably, the unit proceeds with determination to a child of the start node or a descendant of the child of the start node.

As the object of determination is limited in the abovementioned manner, the tree structure where the user traced to the start node is not changed. That is, the tree structure the user understands its structure is not changed. If the start node further has sibling nodes, it is preferable to make the brother nodes following to the start node in the order among the brother nodes the object of determination. In most cases, the user understands the structure of the preceding sibling nodes in the document order. As further ascendants of the parents of the start node may have nodes following to the start node, the nodes may be added to the objects of the determination as required. This is because the nodes placed in the forward direction in the document order may be unknown to the user, i.e., the tree structure of the nodes may not be traced by the user operating the Web content.

The determining unit 210 determines whether the tree structure needs to be changed or not based on a presentation aspect 211 of the respective displayed object in the Web contents 400. The presentation aspect designates operations of the displayed object such as a displayed place, area, color, blinking and the like. The information can be obtained by cooperating with application software such as a display controller 114, an operating system or a Web browser and the like.

For example, as the displayed object 403 is included in the displayed object 401 and directly included in the displayed object 402, the node 403 is preferably a child node of the node 402. Similarly, each of the nodes 404, 405, and 406 is preferably the child node of the node 402. As the nodes 407 and 408 are directly included in the image object 406 of the DVD, each of the nodes is preferably a child node of the node 406. In conclusion, the tree structure 500 shown in FIG. 5 is preferably changed to the tree structure 600 shown in FIG. 6.

The determination is sent to the content structure changing unit 212. The content structure changing unit 212 updates the tree structure stored in the content structure storing unit 206 to the new tree structure 600. The rewritten tree structure is sent to an outside software program or system as required through the content structure outputting unit 214 (215). The term ‘as required’ means ‘in response to a request from another software program or another hardware that needs the information and processes a structured document such as an XML document by cooperating with the computer device 100 according to an aspect of the present invention as described above with reference to FIG. 3.

### D. Outline of Operation

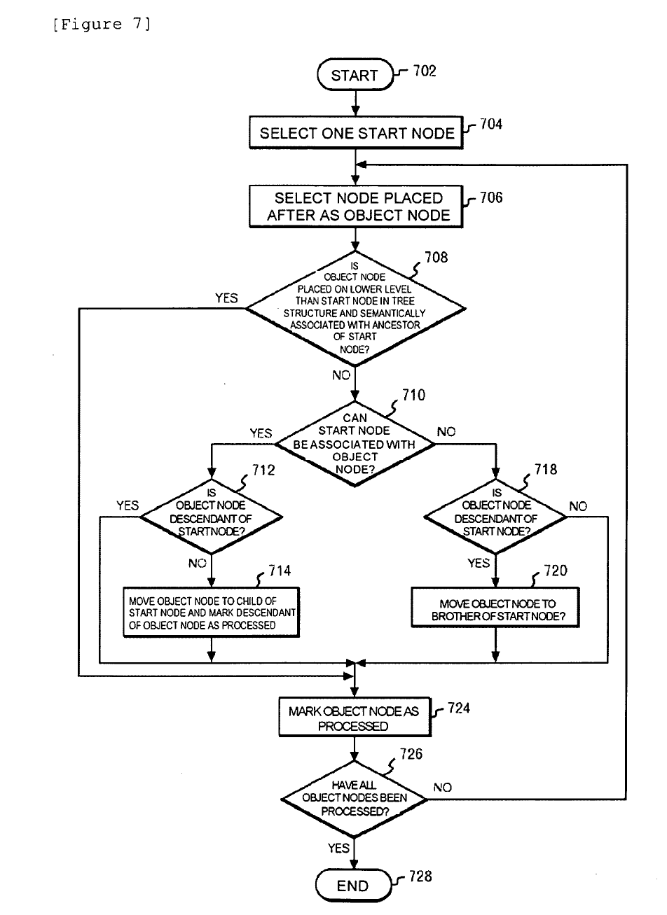

The operations of the computer device 100 have been described in detail. Here, the operations are outlined with reference to FIG. 7.

The changing of the tree structure is triggered by operations performed by a user on the XML corresponding Web browser 304, for example, selection of a displayed object, or activation of the XML parser 306 (step 702). First, the node selecting unit 208 selects the start node (step 704). As described above, the start node may be a node whose content is being read aloud by the audio processing unit 126. Then, the node selecting unit 208 selects a node that is placed following to the start node and has not been selected as an object of the determination by the determining unit 210 (step 706). The criteria for the selection have been described.

If the determining unit 210 determines that the selected node (also called as an object node) is placed lower than the start node in the tree structure and semantically associated with an ancestor of the start node (step 708), the tree structure is not changed. Determination on whether or not the node is associated with the ancestor may be based on the presentation aspect of the displayed object as mentioned above. Then, a flag indicating that the selected node has been processed is given (step 724). The flag may be added to the tree structure of the content structure storing unit 206.

If the selected node is placed on the lower level than the start node and not associated with an ancestor of the start node (step 708), the determining unit 210 determines whether the start node can be associated with the object node or not (step 710). If the start node can be associated with the object node, the determining unit 210 determines whether or not the selected node is a descendant of the start node (step 712). If the node is a descendant, the tree structure is not changed (step 724). If otherwise, the selected node is moved to a child of the start node and the tree structure is changed (step 714). Then, the flag indicating that the selected node has been processed is recorded.

If it is determined that the selected node cannot be associated with the start node at step 710, whether or not the selected node is a descendant of the start node is determined by the determining unit 210 (step 718). If the selected node is not a descendant of the start node, the tree structure is not changed and the flag indicating that the selected node has been processed is added to the tree structure (step 724). If the selected node is a descendant of the start node, the content structure changing unit 212 changes the tree structure in the content structure storing unit 206 so that the selected node is moved to a preceding sibling of the start node (step 720). Then, information that the selected node has been processed is added to the tree structure (step 724).

When the tree structure has been changed for an objective node (step 726), the processing ends (step 728). The region that is preferably a node to be processed has been described.

### E. Another Embodiment

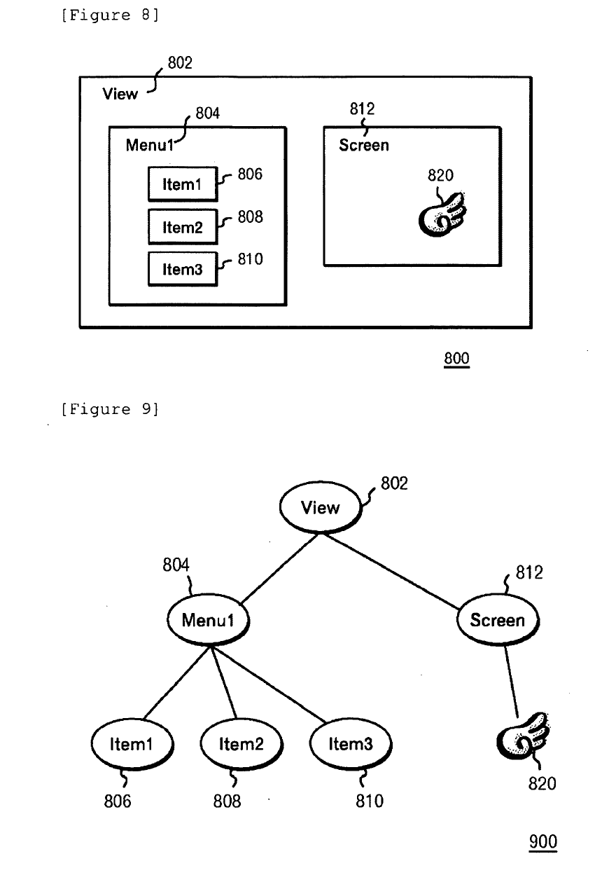

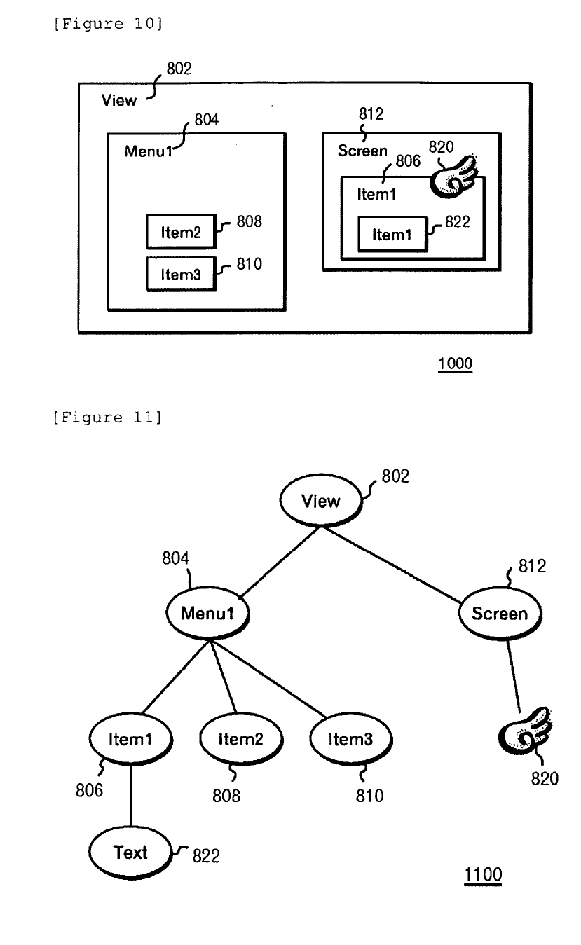

Finally, how the tree structure is changed when the computer device 100 according to an aspect of the present invention processes a Web content 800 (FIG. 8) will be described with reference to FIG. 8 to FIG. 11.

The Web content 800 differs from the Web content 400 that is formed only by static objects in that it includes a dynamic displayed object such as animation. The computer device 100 according to the present invention can change the tree structure for the Web content so that a user can correctly understand the Web content.

The Web content includes a view object 802, which is a background, a menu 1 object 804, and objects of Item1 806, Item2 808, Item3 813, which are detailed items in the menu. A screen object 812 is placed on the right of the menu object.

An icon that moves around the Web content is displayed in the screen object. The moving around icon has no semantic relation with the abovementioned fixed object. The icon is an advertising banner or a mascot icon mimicking the shape of animal and moves around on the screen.

FIG. 9 shows the tree structure of the Web content 800. When the user clicks Item1 806, Item 1 moves onto the screen object 812. Text 822 associated with Item 1 is displayed at the destination of the movement. Here, according to an embodiment of the present invention, the start nod of the tree structure changing is Item1 (806 in FIG. 11). This is because the user clicked on Item1. In this case, according to the preferred embodiment, only the newly appeared Text 822 node is selected by the node selecting unit 208 and an icon 820, which is a child node of Screen 812 node, is not selected. According to the above described criteria for the displayed aspect of the object, Text object 822 is directly included in Item1 806. Thus, the tree structure is updated to make Text 822 a child of Item1 806 (FIG. 11).

As the node selecting unit 208 does not select the icon 820 as an object to be processed, the tree structure is kept as it is. As a result of the abovementioned processing, even if Item1 806 has moved onto the Screen 812, the user who clicked on Item1 806 can just listen to the guide for Text 822 without being affected (audio reading) by a guide for the icon 820 that is encountered at the destination of the movement by chance. In such a manner, the user is enabled to correctly understand the semantics structure of the Web content whose displayed content changes in response to the operation of the user.

The non-visual content access using the audio reading is characterized in that the band width for obtaining information (the amount of information that is available for a user to obtain for each unit time) is significantly narrower than in the case of visual access. If the content is accessed by using a screen reader or the like, the user gradually recognizes the entire structure of the content by accessing (traversing) respective displayed contents in order according to navigation made by audio or the like. The non visual access differs from the visual access that allows a user to recognize the entire structure of the contents at a glance in that the non visual access needs much time in such traversing.

In the content including a motion picture, the structure of the content largely changes in course of the access by the user. Therefore, the user needs the abovementioned traversing to recognize the structure of the contents each time the structure changes. That hinders the ever-increasing dynamic multi-media contents from being visually accessed.

The abovementioned present invention minimizes changing of the tree structure by limiting the changing to the part surrounding the displayed object to which the user pays attention so that the user can correctly position the displayed content subjected to the changing based on the structure of the content that the user has already recognized.

That which is claimed is:

1. A computer program product embodied in tangible computer usable medium for analyzing a structured electronic document that is represented in a tree structure, in which an object to be processed in a computer forms one of a plurality of tree nodes, the computer program product comprising program code for:
selecting a predetermined node from said tree nodes;
selecting at least one other tree node that is placed after said predetermined node in said tree structure;
determining whether semantics of said selected other tree node are associated with semantics of said predetermined tree node or not; and
changing said tree structure to make said other tree node a child tree node of said predetermined tree node if it is determined that said semantics of said selected other tree node are associated with said semantics of said predetermined tree node.

2. The computer program product according to claim 1, wherein said program code for determining performs determination based on a presentation aspect of each object corresponding to said predetermined tree node and said other tree node.

3. The computer program product according to claim 2, wherein said presentation aspect is a presenting aspect on a computer display.

4. The computer program product according to claim 3, wherein said program code for determining further determines that the semantics of said other tree node and the semantics of said predetermined tree node are associated with each other, if at least a part of a first object corresponding to said predetermined tree node is overlapping a second object corresponding to said other tree node on said computer display.

5. The computer program product according to claim 1, wherein the computer program product further comprises program code for changing said tree structure so that said other tree node becomes a preceding sibling tree node of said predetermined tree node, if it is not determined that said semantics of said selected other tree node are not associated with the semantics of said predetermined tree node and said other tree node is a descendant of said predetermined tree node.

6. The computer program product according to claim 1, wherein said program code for selecting said other tree node selects at least one said other tree node from preceding sibling tree nodes of said predetermined tree node or descendant tree nodes of said preceding sibling tree nodes.

7. The computer program product according to claim 6, wherein said program code for selecting said other tree node selects at least one said other tree node from parent tree nodes of said predetermined tee node or descendant tree nodes of said parent tree nodes placed after said predetermined tree node.

8. The computer program product according to claim 1, wherein said program code for changing said tree structure changes said tree structure while keeping relationship between said other tree node and descendant tree nodes of said other tree node.

9. The computer program product according to claim 1, wherein said program code for selecting said predetermined node selects said predetermined tree node based on input from a user.

10. The computer program product according to claim 9, wherein said program code for selecting said predetermined tree node selects the node corresponding to the object that is selected by the user on a computer display as said predetermined tree node.

11. The computer program product according to claim 1, wherein said program code for selecting said predetermined tree node selects the node corresponding to the object whose content is read aloud as said predetermined tree node.

12. A computer for editing a structured electronic document that is represented by a tree structure, in which an object to be processed in a computer forms one of a plurality of nodes, the computer comprising:
a first selecting module for selecting a predetermined node from said nodes;
a second selecting module for selecting at least one other node that is placed after said predetermined node in said tree structure;
a determining module for determining whether semantics of said selected other node are associated with semantics of said predetermined node or not; and
a changing module for changing said tree structure to make said another node a child node of said predetermined node if it is determined that semantics of said selected other node are associated with said semantics of said predetermined node.

13. A method for editing a structured electronic document that is represented in a tree structure, in which an object to be processed in a computer forms one of a plurality of nodes, the method comprising:
selecting a predetermined node from said nodes;
selecting at least one other node that is placed after said predetermined node in said tree structure;
determining whether semantics of said selected other node are associated with semantics of said predetermined node or not; and
changing said tree structure to make said other node a child node of said predetermined node if it is determined that said semantics of said selected other node are associated with said semantics of said predetermined node.
